(19) United States
(12) Patent Application Publication
(10) Pub. No.: US 2024/0036163 A1
(43) Pub. Date: Feb. 1, 2024

(54) SYSTEM AND METHOD FOR BEAM MANAGEMENT WITH RADAR BASED RF EXPOSURE ESTIMATION IN MOBILE DEVICES

(71) Applicant: Samsung Electronics Co., Ltd., Suwon-si (KR)

(72) Inventors: Anum Ali, Plano, TX (US); Jianhua Mo, Allen, TX (US); Vutha Va, Plano, TX (US); Boon Loong Ng, Plano, TX (US)

(21) Appl. No.: 18/068,515

(22) Filed: Dec. 19, 2022

Related U.S. Application Data
(60) Provisional application No. 63/393,486, filed on Jul. 29, 2022.

(51) Int. Cl. G01S 7/40; G01S 13/87; G01S 13/76

(52) U.S. Cl. CPC G01S 7/4013; G01S 13/878; G01S 7/40; G01S 13/762

(57) ABSTRACT

A method includes determining whether to activate one or more radar modules of a user equipment (UE) based on whether the UE performs initial access or beam failure recovery. The method also includes, in response to determining that the one or more radar modules are to be activated: activating all of the one or more radar modules in a time sequence, one or multiple radar modules at a time; determining a power backoff for at least one communication module of the UE; and determining a UE uplink (UL) beam, a UE downlink (DL) beam, a base station (BS) UL beam, and a BS DL beam based on the power backoff and a sweeping of beams of the UE. The sweeping occurs for the beams of the UE that have a power backoff that is less than a threshold.

### CROSS-REFERENCE TO RELATED APPLICATIONS AND CLAIM OF PRIORITY

The present application claims priority to U.S. Provisional Patent Application Ser. No. 63/393,486 filed on Jul. 29, 2022. The content of the above-identified patent document is incorporated herein by reference.

### TECHNICAL FIELD

The present disclosure relates generally to wireless communication systems and, more specifically, the present disclosure relates to a system and method for beam management with radar based radio frequency (RF) exposure estimation in mobile devices.

### BACKGROUND

To ensure the safety of users, regulatory bodies (e.g., the Federal Communications Commission (FCC) in the US) have regulations governing RF exposure from mobile devices on the human body. Some existing techniques take a very conservative approach to meet the regulations, e.g., always assuming worst-case exposure level corresponding to a case where there is a human body part on the surface of the device. When there is no exposure, the device can transmit with maximum power; this state can be referred to as “no power backoff” or “zero power backoff.” When there is an exposure, the device applies power backoff to make sure the regulatory criteria are met. Particularly, when the device assumes worst case exposure, the device needs to assume worst case power backoff to ensure that regulatory requirements are met. A strategy based on always assuming the worst-case exposure can meet the regulatory requirements, but it forces the communication module to operate sub-optimally (e.g., transmitting with less power), and thus the device might not be able to always support high data rate services.

### SUMMARY

The present disclosure relates to wireless communication systems and, more specifically, the present disclosure relates to a system and method for beam management with radar based radio frequency (RF) exposure estimation in mobile devices.

In one embodiment, a method includes determining whether to activate one or more radar modules of a user equipment (UE) based on whether the UE performs initial access or beam failure recovery. The method also includes, in response to determining that the one or more radar modules are to be activated: activating all of the one or more radar modules in a time sequence, one or multiple radar modules at a time; determining a power backoff for at least one communication module of the UE; and determining a UE uplink (UL) beam, a UE downlink (DL) beam, a base station (BS) UL beam, and a BS DL beam based on the power backoff and a sweeping of beams of the UE. The sweeping occurs for the beams of the UE that have a power backoff that is less than a threshold.

In another embodiment, a UE includes a transceiver and a processor operably connected to the transceiver. The processor is configured to: determine whether to activate one or more radar modules based on whether the UE performs initial access or beam failure recovery; in response to determining that the one or more radar modules are to be activated: activate all of the one or more radar modules in a time sequence, one or multiple radar modules at a time; determine a power backoff for at least one communication module; and determine a UE UL beam, a UE DL beam, a BS UL beam, and a BS DL beam based on the power backoff and a sweeping of beams of the UE, wherein the sweeping occurs for the beams of the UE that have a power backoff that is less than a threshold.

In yet another embodiment, a non-transitory computer readable medium includes program code that, when executed by a processor of a UE, causes the UE to: determine whether to activate one or more radar modules of the UE based on whether the UE performs initial access or beam failure recovery; in response to determining that the one or more radar modules are to be activated: activate all of the one or more radar modules in a time sequence, one or multiple radar modules at a time; determine a power backoff for at least one communication module of the UE; and determine a UE UL beam, a UE DL beam, a BS UL beam, and a BS DL beam based on the power backoff and a sweeping of beams of the UE, wherein the sweeping occurs for the beams of the UE that have a power backoff that is less than a threshold.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNB according to embodiments of the present disclosure;

FIG. 3 illustrates an example UE according to embodiments of the present disclosure;

FIG. 4 illustrates an example beamforming architecture according to embodiments of the present disclosure;

FIG. 5 illustrates a high level architecture of an example common monostatic radar according to embodiments of the present disclosure;

FIG. 6 illustrates an example UE with multiple communication modules and multiple radar modules according to embodiments of the present disclosure;

FIGS. 7A through 7C illustrate three example fields of view for a UE radar according to embodiments of the present disclosure;

FIG. 8 illustrates an example process for determining module level power back off according to embodiments of the present disclosure;

FIG. 9 illustrates an example UE in which each radar module has two antennas according to embodiments of the present disclosure;

FIG. 10 illustrates an example process for determining angular region level power back off according to embodiments of the present disclosure;

FIG. 11 illustrates an example UE with a relatively large number of radar antennas according to embodiments of the present disclosure;

FIG. 12 illustrates an example process for determining beam level power back off according to embodiments of the present disclosure;

FIG. 13 illustrates a beam management process;

FIG. 14 illustrates an example process for determining the best UL beams using power backoff according to embodiments of the present disclosure;

FIG. 15 illustrates an example process for determining the best UE and BS beams for multiple scenarios according to embodiments of the present disclosure;

FIG. 16 illustrates an example process for determining whether to prefer the UL or DL according to embodiments of the present disclosure;

FIG. 17 illustrates an example process for pruning the beams during the initial access or beam failure recovery phase, according to embodiments of the present disclosure;

FIG. 18 illustrates a timeline showing periodic activation of the UE radar according to embodiments of the present disclosure;

FIG. 19 illustrates a timeline showing on demand activation of the UE radar according to embodiments of the present disclosure;

FIG. 20 illustrates an example process for module sweeping and switching without using radar information, according to embodiments of the present disclosure;

FIG. 21 illustrates an example process for module sweeping using radar information according to embodiments of the present disclosure;

FIG. 22 illustrates an example process for module switching using radar information according to embodiments of the present disclosure; and

FIG. 23 illustrates method for beam management with radar based RF exposure estimation according to embodiments of the present disclosure.

### DETAILED DESCRIPTION

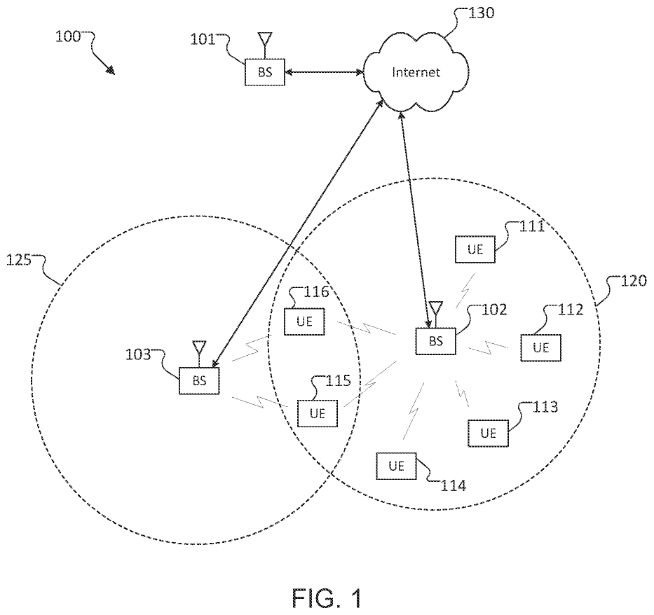

FIGS. 1 through 23, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

The present disclosure covers several components which can be used in conjunction or in combination with one another or can operate as standalone schemes. Certain embodiments of the disclosure may be derived by utilizing a combination of several of the embodiments listed below. Also, it should be noted that further embodiments may be derived by utilizing a particular subset of operational steps as disclosed in each of these embodiments. This disclosure should be understood to cover all such embodiments.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programming, or a combination thereof for performing beam management with radar based RF exposure estimation. In certain embodiments, one or more of the gNBs 101-103 includes circuitry, programming, or a combination thereof for performing beam management with radar based RF exposure estimation.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

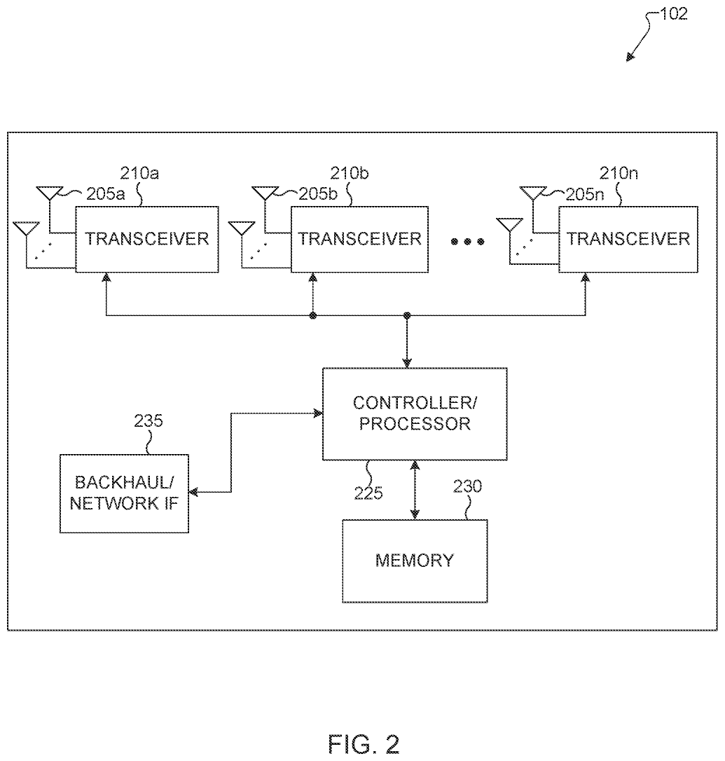

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam management with radar based RF exposure estimation. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

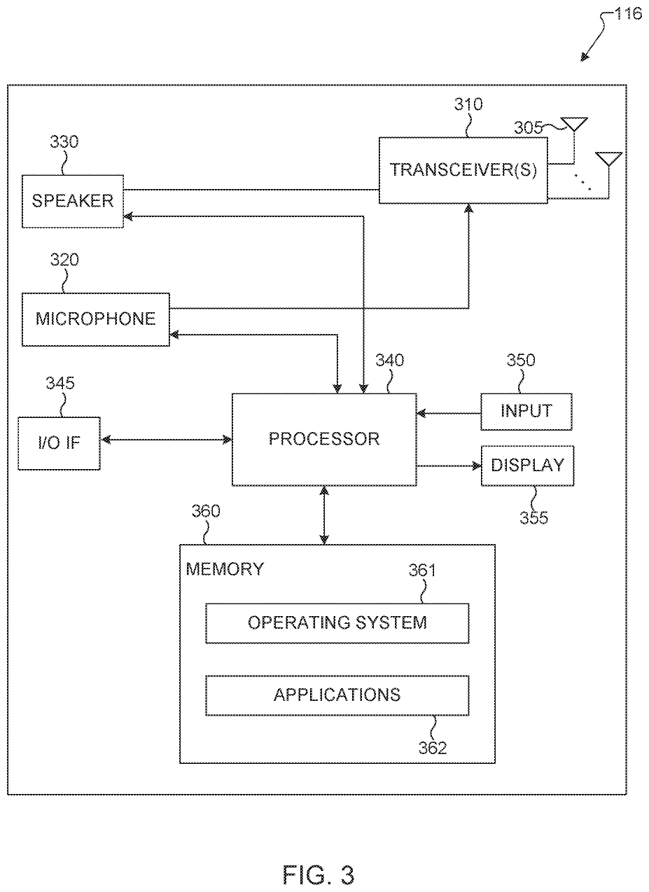

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for beam management with radar based RF exposure estimation. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 (which includes for example, a touchscreen, keypad, etc.) and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

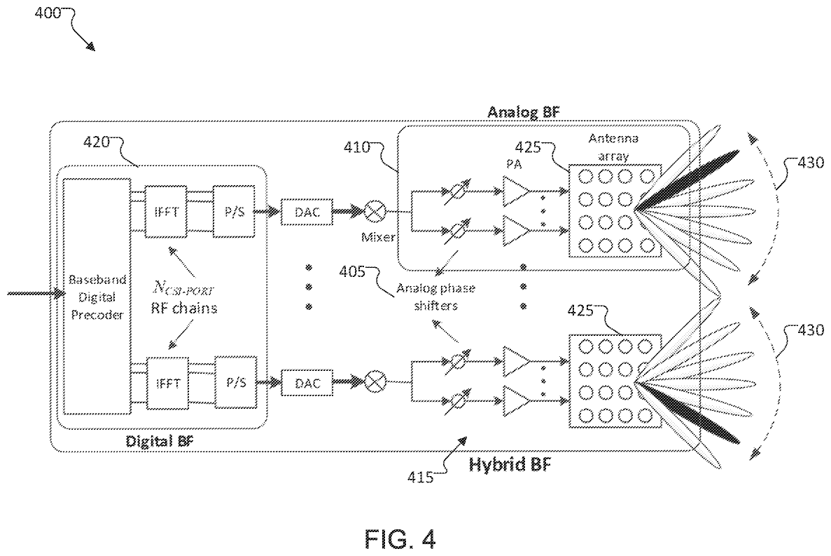

FIG. 4 illustrates an example beamforming architecture 400 according to embodiments of the present disclosure. The embodiment of the beamforming architecture 400 illustrated in FIG. 4 is for illustration only. FIG. 4 does not limit the scope of this disclosure to any particular implementation of the beamforming architecture 400. In certain embodiments, one or more of gNB 102 or UE 116 can include the beamforming architecture 400. For example, one or more of antenna 205 and its associated systems or antenna 305 and its associated systems can be configured the same as or similar to the beamforming architecture 400.

Re1.14 LTE and Re1.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports—which can correspond to the number of digitally precoded ports—tends to be limited due to hardware constraints (such as the feasibility to install a large number of analog-to-digital converts/digital-to-analog converts (ADCs/DACs at mmWave frequencies)).

In the example shown in FIG. 4, the beamforming architecture 400 includes analog phase shifters 405, an analog beamformer (BF) 410, a hybrid BF 415, a digital BF 420, and one or more antenna arrays 425. In this case, one CSI-RS port is mapped onto a large number of antenna elements in antenna arrays 425, which can be controlled by the bank of analog phase shifters 405. One CSI-RS port can then correspond to one sub-array which produces a narrow analog beam through analog beamforming by analog BF 410. The analog beam can be configured to sweep 430 across a wider range of angles by varying the phase shifter bank 405 across symbols or subframes. The number of sub-arrays (equal to the number of RF chains) is the same as the number of CSI-RS ports NCSI-PORT. The digital BF 420 performs a linear combination across NCSI-PORT analog beams to further increase precoding gain. While analog beams are wideband (hence not frequency-selective), digital precoding can be varied across frequency sub-bands or resource blocks.

Since the above system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL transmit (TX) beam (also termed “beam indication”), measuring at least one reference signal for calculating and performing beam reporting (also termed “beam measurement” and “beam reporting”, respectively), and receiving a DL or UL transmission via a selection of a corresponding receive (RX) beam.

Additionally, the beamforming architecture 400 is also applicable to higher frequency bands such as >52.6G Hz (also termed the FR4). In this case, the beamforming architecture 400 can employ only analog beams. Due to the O2 absorption loss around 60 GHz frequency (˜10 decibels (dB) additional loss @100 m distance), larger numbers of and sharper analog beams (hence larger number of radiators in the array) will be needed to compensate for the additional path loss.

Using the beamforming architecture 400, the gNB 102 could utilize one or multiple transmit beams to cover the whole area of one cell. The gNB 102 may form a transmit beam by applying suitable gains and phase settings to an antenna array. The transmit gain, i.e., the amplification of the power of the transmitted signal provided by a transmit beam, is typically inversely proportional to the width or area covered by the beam. At lower carrier frequencies, the more benign propagation losses may make it feasible for the gNB 102 to provide coverage with a single transmit beam, i.e., ensure adequate received signal quality at all UE locations within the coverage area via the usage of a single transmit beam. In other words, at lower transmit signal carrier frequencies, the transmit power amplification provided by the transmit beam with a width large enough to cover the area may be sufficient to overcome the propagation losses to ensure adequate received signal quality at all UE locations within the coverage area. However, at higher signal carrier frequencies, the transmit beam power amplification corresponding to the same coverage area may not be sufficient to overcome the higher propagation losses, resulting in a degradation of received signal quality at UE locations within the coverage area. In order to overcome such a received signal quality degradation, the gNB 102 may form a number of transmit beams, each providing coverage over a region narrower than the overall coverage region, but providing the transmit power amplification sufficient to overcome the higher signal propagation loss due to the usage of higher transmit signal carrier frequencies. The UE 116 may also form receive beams to increase the signal-to-interference-and-noise ratio (SINR) at the receiver. Likewise, in the uplink, the UE 116 may form transmit beams and the gNB 102 may form receive beams.

To assist the UE 116 in determining its RX and/or TX beam, a beam sweeping procedure can be employed, which includes the gNB 102 transmitting a set of transmit beams to sweep the cell area and the UE 116 measuring the signal quality on different beams using its receive beams. To facilitate candidate beam identification, beam measurement and beam quality reporting, the gNB 102 configures the UE 116 with one or more RS resources (e.g., SS Block, Periodic/Aperiodic/Semi-Persistent CSI-RS resources or CRIs) corresponding to a set of TX beams. An RS resource refers to a reference signal transmission on a combination of one or more time (OFDM symbol)/frequency (resource element)/spatial (antenna port) domain locations. For each RX beam, the UE 116 reports different TX beams received using that RX beam, ranked in order of signal strength (RSRP) and optionally CSI (CQI/PMI/RI)). Based on the UE's measurement report feedback, the gNB 102 indicates the UE 116 with one or more Transmission Configuration Indicator (TCI) states for reception of PDCCH and/or PDSCH.

In 5G, the UE 116 can be equipped with multiple antenna elements. There can also be one or more antenna modules fitted on the UE 116, where each module can have one or more antenna elements. Beamforming can be an important factor when the UE 116 tries to establish a connection with the gNB 102. To compensate for the narrower analog beamwidth in mmWave, analog beams sweeping can be employed to enable wider signal reception or transmission coverage for the UE 116. A beam codebook comprises a set of codewords, where a codeword is a set of analog phase shift values, or a set of amplitude plus phase shift values, applied to the antenna elements, in order to form an analog beam.

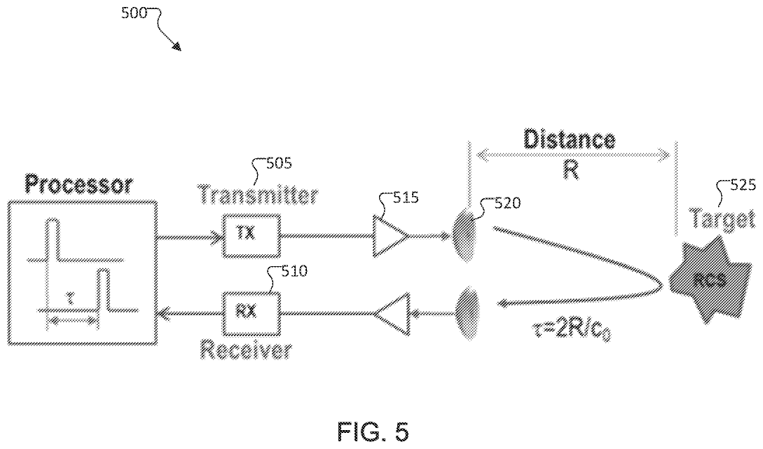

A common type of radar is the “monostatic” radar, characterized by the fact that the transmitter of the radar signal and the receiver for its delayed echo are, for all practical purposes, in the same location. FIG. 5 shows a high level architecture of an example common monostatic radar system 500, i.e., the transmitter 505 and receiver 510 are co-located, either by using a common antenna, or are nearly co-located, while using separate, but adjacent antennas. Monostatic radars are assumed coherent, i.e., the transmitter 505 and receiver 510 are synchronized via a common time reference.

In its most basic form, a radar pulse is generated as a realization of a desired “radar waveform,” modulated onto a radio carrier frequency and transmitted through a power amplifier 515 and antenna 520 (such as a parabolic antenna), either omni-directionally or focused into a particular direction. Assuming a “target” 525 at a distance R from the radar location and within the field-of-view of the transmitted signal, the target 525 will be illuminated by RF power density pₜ (e.g., in units of W/m²) for the duration of the transmission. To first order, pₜ can be described as:

$${p}_{t} = \frac{{P}_{T}}{4 π {R}^{2}} {G}_{T} = \frac{{P}_{T}}{4 π {R}^{2}} \frac{{A}_{T}}{( {λ}^{2} / 4 π )} = {P}_{T} \frac{{A}_{T}}{{λ}^{2} {R}^{2}} ,$$

where P_{T} is the transmit power[W]; G_{T}, A_{T} are the transmit antenna gain [dBi] and the effective aperture area [m²]; λ is the wavelength of the radar signal RF carrier signal [m]; and R is the target distance [m]. In this equation, the effects of atmospheric attenuation, multi-path propagation, antenna losses, etc., have been neglected.

The transmit power density impinging onto the target surface will lead to reflections depending on the material composition, surface shape, and dielectric behavior at the frequency of the radar signal. Note that off-direction scattered signals are typically too weak to be received back at the radar receiver 510, so only direct reflections will contribute to a detectable receive signal. In essence, the illuminated area(s) of the target 525 with normal vectors pointing back at the receiver 510 will act as transmit antenna apertures with directivities (gains) in accordance with their effective aperture area(s). The reflected-back power can be described as:

$${P}_{refl} = {p}_{t} {A}_{t} {G}_{t} ∼ {p}_{t} {A}_{t} {r}_{t} \frac{{A}_{t}}{( {λ}^{2} / 4 π )} = {p}_{t} R C S ,$$

where P_{refl} is the effective (isotropic) target-reflected power [W]; Aₜ, rₜ, Gₜ are the effective target area normal to the radar direction [m²], reflectivity of the material and shape [0, . . . , 1], and corresponding aperture gain [dBi]; and RCS is the radar cross section [m²].

Note that the radar cross section, RCS, is an equivalent area that scales proportional to the actual reflecting area-squared, inversely proportional with the wavelength-squared, and is reduced by various shape factors and the reflectivity of the material itself. For a flat, fully reflecting minor of area Aₜ, large compared with λ², RCS=4π Aₜ²/λ². Due to the material and shape dependency, it is generally not possible to deduce the actual physical area of a target 525 from the reflected power, even if the target distance is known (hence the existence of stealth objects that choose material absorption and shape characteristics carefully for minimum RCS).

The target-reflected power at the receiver location results from the reflected-power density at the reverse distance R, collected over the receiver antenna aperture area:

$${P}_{R} = \frac{{P}_{r e f l}}{4 π {R}^{2}} {A}_{R} = {P}_{T} \cdot RCS \frac{{A}_{T} {A}_{R}}{4 π {λ}^{2} {R}^{4}} ,$$

where P_{R} is the received, target-reflected power [W], and A_{R} is the receiver antenna effective aperture area [m²] (which may be same as A_{T}).

The radar system 500 is usable as long as the receiver signal exhibits sufficient signal-to-noise ratio (SNR), the particular value of which depends on the waveform and detection method used. Generally, in its simplest form:

$$S N R = \frac{{P}_{R}}{kT \cdot B \cdot F} ,$$

where kT is Boltzmann's constant x temperature [W/Hz], B is the radar signal bandwidth [Hz], and F is the receiver noise factor (degradation of receive signal SNR due to noise contributions of the receiver circuit itself).

In case the radar signal is a short pulse of duration (width) Tₚ, it will be apparent that the delay t between the transmission and reception of the corresponding echo will be equal to τ=2 R/c, where c is the speed of light propagation in the medium (air). In case there are several targets at slightly different distances, it will be equally apparent that the individual echos can be distinguished as such only if the delays differ by at least one pulse width, and hence the range resolution of the radar will be ΔR=cΔτ/2=cTₚ/2. Further considering that a rectangular pulse of duration Tₚ exhibits a power spectral density P(ƒ)˜(sin (πƒTₚ)/(πƒTₚ))² with the first null at its bandwidth B=1/Tₚ, the range resolution of a radar is fundamentally connected with the bandwidth of the radar waveform via ΔR=c/2 B.

As discussed above, regulatory bodies have regulations governing RF exposure from mobile devices on the human body. Some existing techniques take a very conservative approach to meet the regulations, e.g., always assuming worst-case exposure level corresponding to a case where there is a human body part on the surface of the device. When there is no exposure, the device can transmit with maximum power; this state can be referred to as “no power backoff” or “zero power backoff.” When there is an exposure, the device applies power backoff to make sure the regulatory criteria are met. Particularly, when the device assumes worst case exposure, the device needs to assume worst case power backoff to ensure that regulatory requirements are met. A strategy based on always assuming the worst-case exposure can meet the regulatory requirements, but it forces the communication module to operate sub-optimally (e.g., transmitting with less power), and thus the device might not be able to always support high data rate services.

The use of radars on mobile devices is becoming more prevalent, due to the ability of a radar to support numerous applications, including maximum permissible exposure (MPE) management. In some MPE management strategies, the radar can determine a power backoff required for the mobile device to ensure that the device does not exceed the exposure limit. Since the power backoff is determined using sensing, the device does not need to assume worst case power backoff. This in turn allows the device to operate more efficiently and support high data rate application when possible. This power back off varies from one device module to another, and from one device beam to another. When the device needs to transmit in the uplink, the transmission power from a particular beam needs to be offset by the determined power offset to meet the exposure limit.

For better understanding of the role of radar in beam management, a certain beam management technique (i.e., beam management without the use of radar) will now be explained. It is assumed that there are M BS beams and N UE beams (e.g., M=56 and N=14). The BS transmits pilots from all its beams sequentially, and the UE receives pilots from all its beams sequentially. Signal strength measurements are made on all of the transmit beams and receive beams. In various examples in this disclosure, reference signal received power (RSRP) is used as the signal quality metric; however, this is merely one example, and other metrics, such as signal-to-interference-and-noise ratio (SINR), signal-to-noise ratio (SNR), or reference signal received quality (RSRQ) are also possible. Based on the measurements, an N×M RSRP table R^{N×M} is constructed. The row index of the largest entry in R gives the best UE beam n*∈{1, . . . , N}, and the column index of the largest entry in R gives the best BS beam m*∈{1, . . . , M}.

If noise is ignored, the RSRP matrix R can be written as R=P_{RSRP}+Gₕ, where P_{RSRP} is the power of the reference signals, and Gₕ is a matrix that represents the total power loss, including the UE beam gain, BS beam gain, and the channel power loss. As there are M BS beams and N UE beams, the Gₕ matrix also has dimensions N×M. If the optimal UE beam n* and the optimal BS beam m* are determined directly from R, the determined beams will be good for DL data transfer, as the received power in DL will be r_{DL}=P_{DL}+Gₕ (n*, m*), where P_{DL} is the power used by the BS for transmitting the DL data. In the UL, however, the power received will be r_{UL}=P_{UL}+Gₕ (n*, m*)−p_{b}(n*). Here, p_{b} is an N dimensional vector that contains power backoff corresponding to all the UE beams. Power back off may be required to meeting the RF exposure limits, and can vary from one UE beam to the other as discussed earlier. As different power backoff levels for different beams are possible, it is possible to have a UE beam n≠n*, that may give a larger r_{UL} if the p_{b}(n)<p_{b}(n*).

Since the transmission power from a device varies from beam to beam, the beam management strategies, which determine the best beam only based on the signal quality metrics, no longer remain optimal. For example, the beam management technique described above is based on the highest RSRP. In the UL, the power backoff means that the best RSRP beam may not be best for UL transmission. Thus, a better approach to find the best UE beam for UL transmission is desired.

To address these and other issues, this disclosure provides systems and methods for beam management with radar based RF exposure estimation. As described in more detail below, the disclosed embodiments take advantage of the presence of the radar modules on the device for MPE management in order to use radar information in the beam management process, i.e., the process of finding and maintaining a suitable beam for communication between the BS and the UE. The disclosed embodiments include various methods of using the radar information to make the beam management process both fast and robust. The disclosed embodiments include a process to determine the best UE and BS beams when the radar is used for RF exposure management, including a process to deal with the cases when the UE and BS beams in UL/DL do not match. The disclosed embodiments also include a process to determine the preference of the UE towards UL/DL when the BS beam for the UL and the DL does not match. The disclosed embodiments also include a process to reduce the beam management overhead during the initial access phase using radar information. The disclosed embodiments also include a process for on-demand operation of the radar for beam management during initial access phase and beam failure recovery phase. The disclosed embodiments also include a process for best module determination using radar information in the module sweeping and/or module switching phase.

Some of the embodiments discussed below are described in the context of a UE performing radar sensing, which can be useful in various applications, including MPE management, proximity sensing, gesture recognition, liveness detection, sleep monitoring, vital sign monitoring, and the like. Of course, these are merely examples. It will be understood that the principles of this disclosure may be implemented in any number of other suitable contexts or systems.

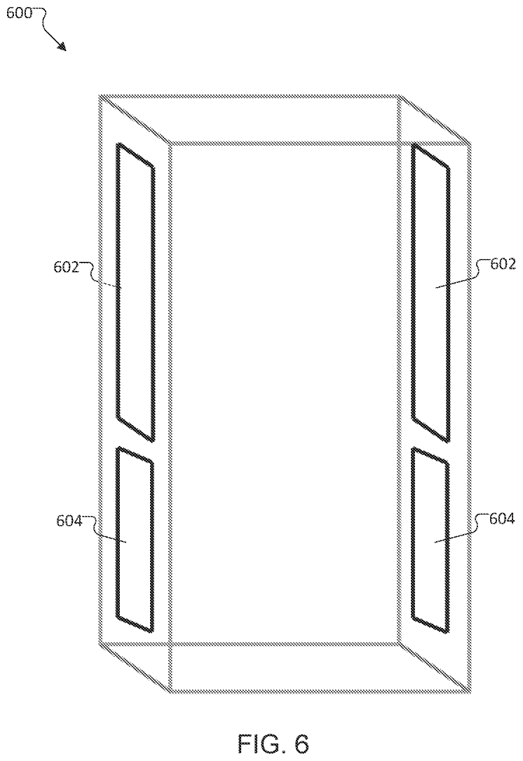

FIG. 6 illustrates an example UE 600 with multiple communication modules and multiple radar modules according to embodiments of the present disclosure. For ease of explanation, the UE 600 will be described as representing the UE 116 of FIG. 1; however, the UE 600 could represent (or be represented by) any other suitable device or system. The embodiment of the UE 600 shown in FIG. 6 is for illustration only. Other embodiments of the UE 600 could be used without departing from the scope of this disclosure.

As shown in FIG. 6, the UE 600 includes multiple (K) communication modules 602 and multiple (K) radar modules 604. In the case of the UE 600, K=2, however other values of K are possible. In some embodiments, the radar modules 604 can be used for power back off determination. Each radar module 604 can have a different field of view (FoV) during operation.

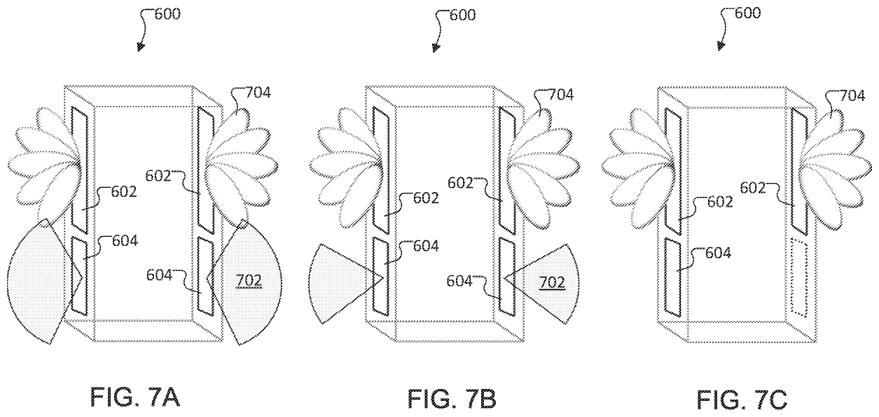

FIGS. 7A through 7B illustrate three example fields of view for a UE radar according to embodiments of the present disclosure.

In FIG. 7A, the UE 600 is shown with full FoV. In full FoV, the angular extent of the coverage 702 of a radar module 604 is similar or identical to the angular extent of the coverage of the communication beams 704 of corresponding communication module 602. In FIG. 7B, the UE 600 is shown with partial FoV by design. Here, the angular extent of the coverage 702 of the radar module 604 is less than the angular extent of the coverage of the communication beams 704 of the corresponding communication module 602, due to the design of the radar module 604. In FIG. 7C, the UE 600 is shown with partial FoV due to radar failure. Here, when one or more of the radar modules 604 of the UE 600 fail, there are communication modules 602 whose corresponding radar module 604 is non-operational.

Note that it is also possible to have a partial FoV by design similar to the configuration shown in FIG. 7C, when no radar module 604 is placed adjacent to one or more communication modules 602. This can happen, e.g., due to form factor considerations when there is not enough space to place a radar module. An example would be a UE 600 in which a communication module 602 is placed on the top and bottom of the UE 600, as well the sides (as shown). In such a case, there may not be enough space on the top of the UE 600 to include a radar module 604.

The power back off required for each communication module 602 is calculated based on estimation by the radar modules 604. Specifically, radar sensing can provide information on the distance from the UE 600 to the target 525 (e.g., the body part that becomes exposed to the communication beams). This information can be used to estimate the exposure level and to appropriately adjust the TX power backoff. In general, the power backoff is inversely proportional to the estimated distance of the target 525, i.e., a higher power backoff when the object is closer to the radar. This is because a closer target 525 would be subject to higher RF exposure. Different power backoff strategies based on the three types of FoVs in FIGS. 7A through 7C will now be discussed.

### Module Level Power Back Off

Module level power back off is suitable when each radar module 604 of the UE 600 has one transmit antenna and one receive antenna, and as such cannot provide any angular information. For this reason, the power back off on all beams in a communication module 602 covered by a particular radar FoV is identical. The radar angle estimation capability with single TX/RX antennas is the same as or similar to that shown in FIG. 7A. Let the power back off assuming worst case exposure be p_{w}. An example value of p_{w} is 6 dB, which was determined through experimentation. Of course, other values of p_{w} are possible. Further, let [symbol] be the set of dysfunctional radars, i.e., [symbol] ⊂ [symbol] ={1, 2, . . . , K}. Then, the power backoff can be expressed as:

p_{b}( [symbol] ₖ)=p_{w}, ∀k∈ [symbol] ,

where [symbol] ₖ is the index of beams in communication module k. This means that for all the communication modules 602 corresponding to dysfunctional radars, the UE 600 needs to assume worst case exposure.

Further, let [symbol] ⊂ [symbol] ={1, 2, . . . , K} be the set of radars with partial FoV. In this case, the power backoff can be expressed as:

p_{b}( [symbol] ₖⁿ)=p_{w}, p_{b}( [symbol] ₖ^{c})= [symbol] ≤p_{w}, ∀k∈ [symbol] ,

where [symbol] is the estimate of power back off from radar k, [symbol] ₖⁿ is the index of beams in communication module k that are not in its corresponding radar's FoV, and [symbol] ₖ^{c} is the index of beams in communication module k that are in its corresponding radar's FoV. Since the manufacturer of the UE 600 has all the specifications of the antenna arrays and the radar modules, the manufacturer knows the indices of the communication beams 704 that are inside the corresponding radar's FoV. Alternatively, the manufacturer can do measurements to get the beam-patterns, e.g., in an anechoic chamber, and the FoV of the radar, and can subsequently determine the communication beams that are inside the corresponding radar's FoV. Herein, a communication beam 704 is considered to be inside the radar FoV if the whole 3 dB beamwidth of the communication beam 704 is inside the corresponding radar's FoV.

Finally, let [symbol] ⊂ [symbol] ={1, 2, . . . , K} be the set of radars with full FoV. In this case, the power backoff can be expressed as:

p_{b}( [symbol] ₖ)= [symbol] , ¤k∈ [symbol] .

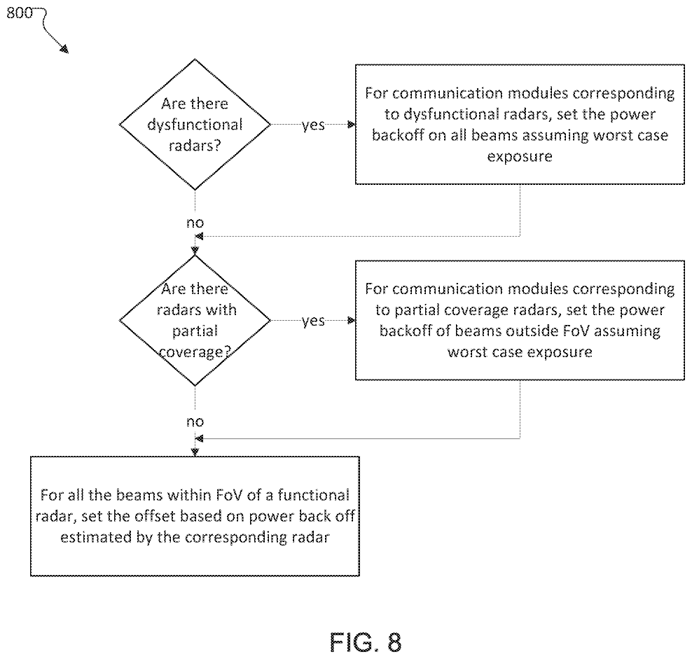

Note that a radar is either dysfunctional, has partial FoV, or full FoV. As such, [symbol] ∪ [symbol] ∪ [symbol] ={1, 2, . . . , K}. FIG. 8 illustrates an example process 800 for determining module level power back off in accordance with the discussion above.

### Angular Region Level Power Back Off

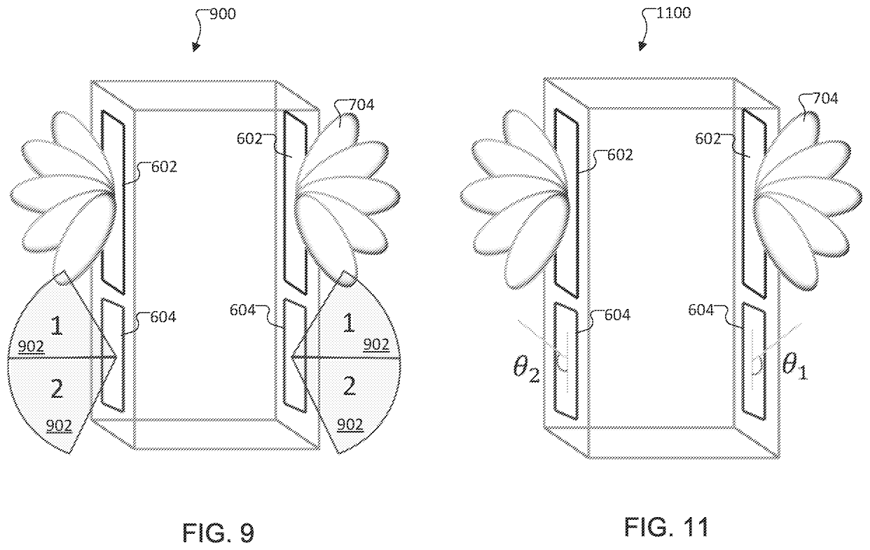

Angular region level power back off is suitable when the radar modules 604 have multiple (e.g., two or three) (TX+RX) antennas so that angle estimation is coarse. For example, FIG. 9 illustrates a UE 900 in which each radar module 604 has two antennas according to embodiments of this disclosure. As shown in FIG. 9, the whole FoV of each radar module 604 can be divided into two angular regions 902, and the power back-off on all the beams inside an angular region 902 is identical. The power backoff calculation for dysfunctional radars, and the beams outside the coverage of the FoV of partial coverage radar needs to be assumed worst case as with the module level power back off discussed earlier. For beams within the radar FoV, the power backoff can be expressed as:

p_{b}( [symbol] ₖ^{c,i})= [symbol] , ∀k∈ [symbol] ,

where [symbol] ₖ^{c,i} is the index of beams in communication module k that are covered by angular region i, and [symbol] is the estimate of power back off from radar k for angular region i. Finally, this can be expressed as:

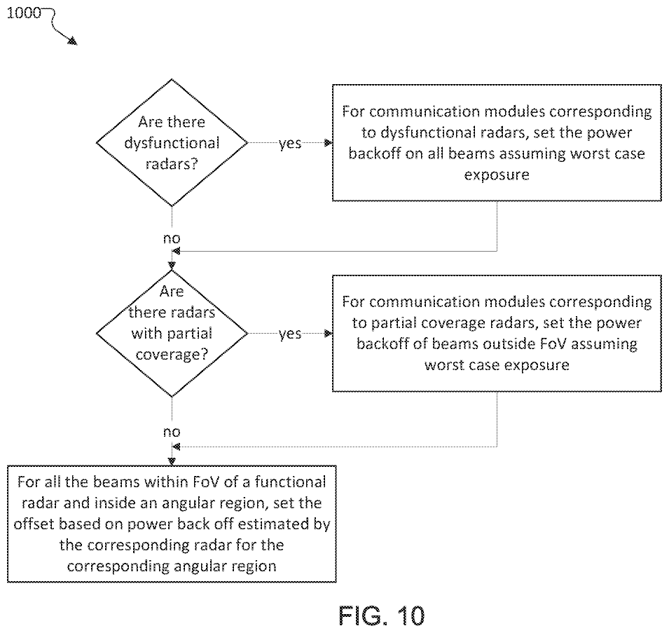

p_{b}( [symbol] ₖⁱ)= [symbol] , ∀k∈ [symbol] ,

where [symbol] ₖⁱ is the index of beam i in communication module k. FIG. 10 illustrates an example process 1000 for determining angular region level power back off in accordance with the discussion above.

### Beam Level Power Back Off

Beam level power back off is suitable when the radar modules 604 have enough antennas (typically more than three), such that the aperture of the (virtual) array is comparable to the corresponding communication module 602. The requirement on the number of radar antennas will thus depend on the number of communication module antennas. FIG. 11 illustrates a UE 1100 with a relatively large number of radar antennas according to embodiments of this disclosure. Once again, for dysfunctional radars and the beams outside the coverage of the FoV of partial coverage radar, the worst-case power back off needs to be assumed as discussed with module level and angular region level power back off. Due to high angle estimation resolution, the power back-off on all the beams inside FoV of a functional radar can be set independently. Let [symbol] ₖ^{c,i} be the index of beam i in communication module k that is covered by the radar FoV. Then the power backoff can be expressed as:

p_{b}( [symbol] ₖ^{c,i})= [symbol] , ∀k∈ [symbol] ,

where [symbol] is the estimate of power back off from radar k for beam i that is covered by the radar FoV. Finally, this can be expressed as:

p_{b}( [symbol] ₖ^{c,i})= [symbol] , ∀k∈ [symbol] .

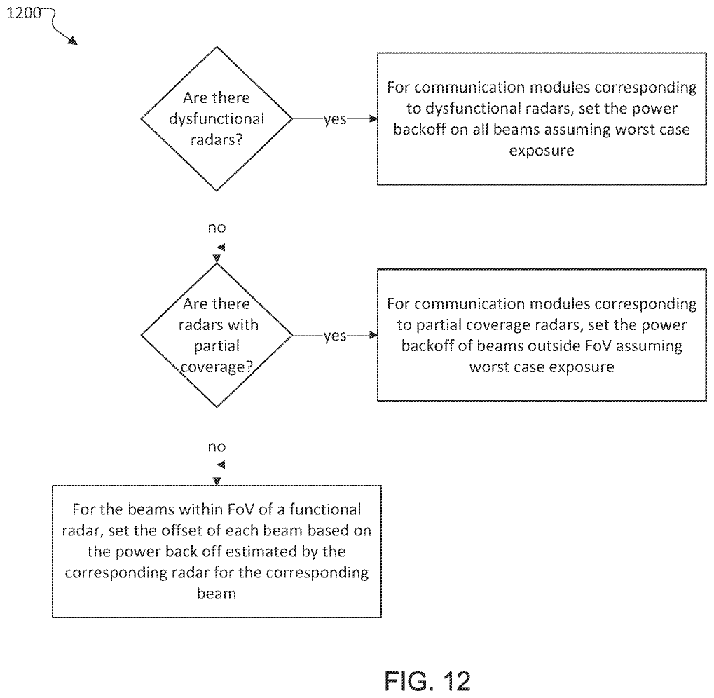

FIG. 12 illustrates an example process 1200 for determining beam level power back off in accordance with the discussion above.

Note that it is possible that on a same device, some radar modules might have a single antenna, e.g., on top or bottom due to tight space constraints, and some radar modules might have more than one antenna, e.g., on the left or right side. As such it is possible that the module level, angular region level, and beam level power back off determination is mixed on a single device.

### Determining Best UE/BS Beams with RF Exposure Management

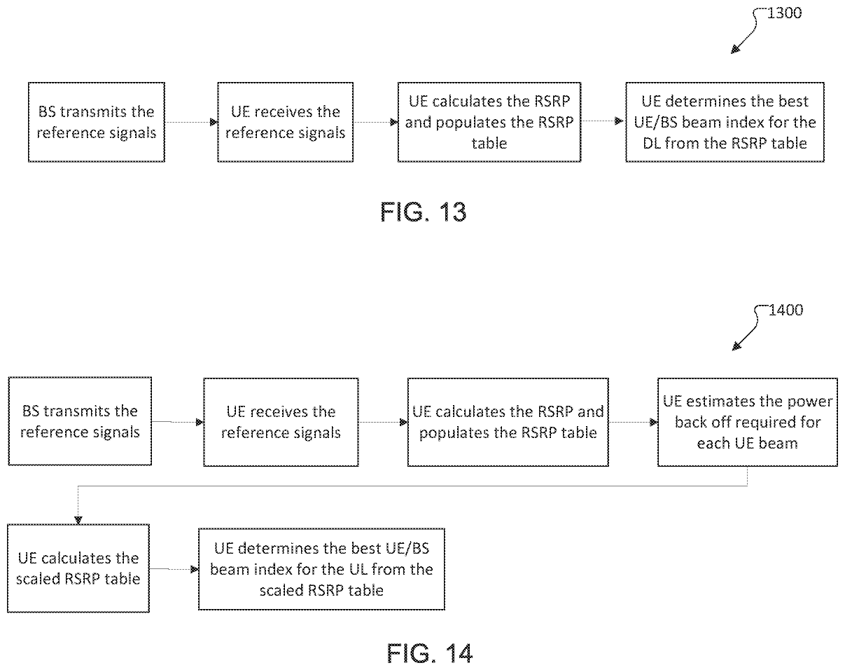

Since the power back off does not impact the best DL beams of the UE or the BS, the process for determining the best UE beam for the DL can be the same as the beam management process 1300 shown in FIG. 13. Specifically, the row index of the largest entry in R gives the best UE beam for DL n*_{DL}∈{1, . . . , N}, and the column index of the largest entry in R gives the best BS beam for DL m*_{DL}∈{1, . . . , M}

For the UL, however, a modification is applied that includes the use of a scaled RSRP table. FIG. 14 illustrates a process 1400 for determining the best UL beams using power backoff according to embodiments of this disclosure. As shown in FIG. 14, a scaled RSRP table R̅ is calculated. The scaled RSRP table is defined as R̅=R−p_{b}×1_{M}^{T}, where 1_{M} is an M dimensional all ones vector, and p_{b} is the power backoff vector calculated using radar (e.g., using one or more of the techniques discussed above, such as module level power back off, angular region level power back off, or beam level power back off). Subsequently, the row index of the largest entry in R̅ gives the best UE beam for UL n*_{UL}∈{1, . . . , N}, and the column index of the largest entry in R̅ gives the best BS beam for UL m*_{UL}∈{1, . . . , M}.

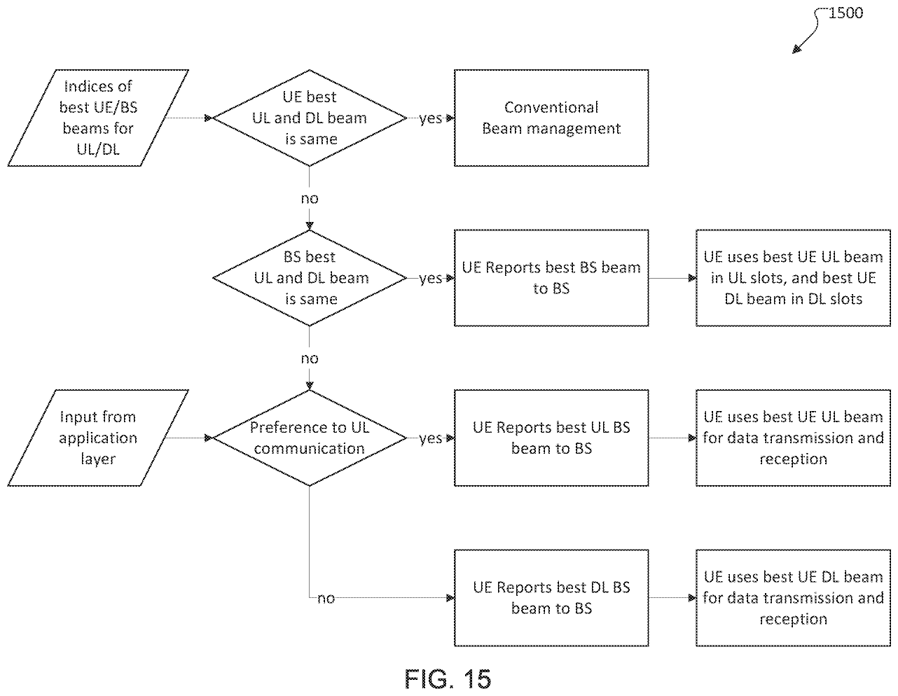

Since the best UE/BS beams for the UL and DL are determined separately for meeting the RF exposure management, it is possible that n*_{UL}≠n*_{DL}, and m*_{UL}≠m*_{DL}. Stated differently, this means that the best UE beam for UL is different than the best UE beam for the DL, and/or the best BS beam for UL is different than the best BS beam for the DL. As such, there are four possible scenarios of interest. FIG. 15 illustrates a process 1500 for determining the best UE and BS beams for all four scenarios according to embodiments of the present disclosure.

Scenario 1: n*=n*_{UL}=n*_{DL} and m*=m*_{UL}=m*_{DL}

In this scenario, no modifications to the beam management process are required, as the best UE and BS beams for the UL and DL are same.

Scenario 2: n*=n*_{UL}=n*_{DL} but m*_{UL}≠m*_{DL}

This scenario implies that the best BS beams in the UL and DL are not the same but the best UE beams in the UL and DL are the same. Since the RF exposure estimation impacts the UE beam determination, this case is not possible, and does not need to be considered for the purposes of this disclosure.

Scenario 3: n*_{UL}≠n*_{DL} but m*=m*_{UL}=m*_{DL}

In this scenario, the best UE beams in the UL and DL are different, but the best BS beams in the UL and DL are the same. Since the UE needs to report the BS beam to the BS, a trivial solution is for the UE to report m* to the BS, which will use m* in the UL and DL, and the UE itself will use n*_{UL} in the UL, and n*_{DL} in the DL.

Scenario 4: n*_{UL}≠n*_{DL} and m*_{UL}≠m*_{DL}:

It is possible that the interaction between the UE and the BS does not assume beam correspondence at the BS side. This means that the BS can use separate beams for the UL and DL communication. In this scenario, however, it is assumed that there is the beam correspondence assumption, which means that the BS uses the same beam in the DL and the UL. Since the best BS beams in the UL and DL are different, and the UE needs to report the best BS beam to the BS, the UE operates to decide whether to report the beam suitable for UL operation or DL operation. Specifically, if the UE decides to prefer UL, then the UE uses n*_{UL} and feeds back m*_{UL} to the BS, and if the UE decides to prefer DL, then the UE uses n*_{DL} and feeds back m*_{DL} to the BS.

### Determining the UL/DL Preference

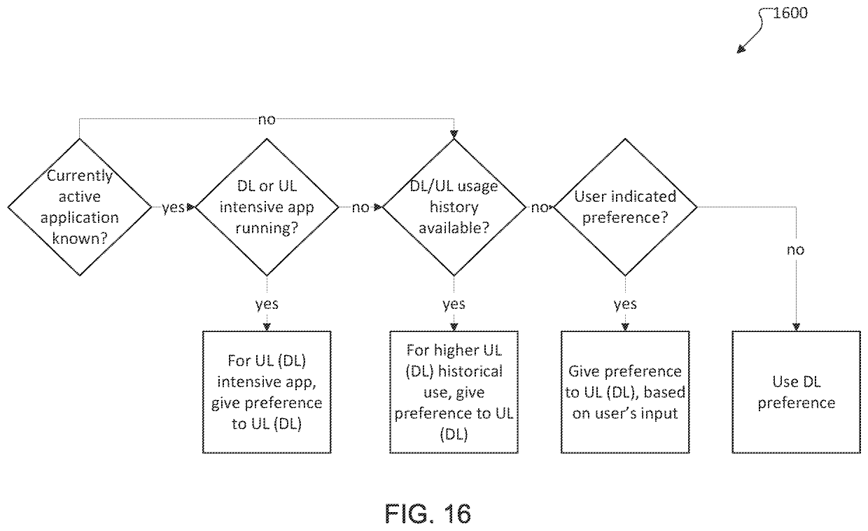

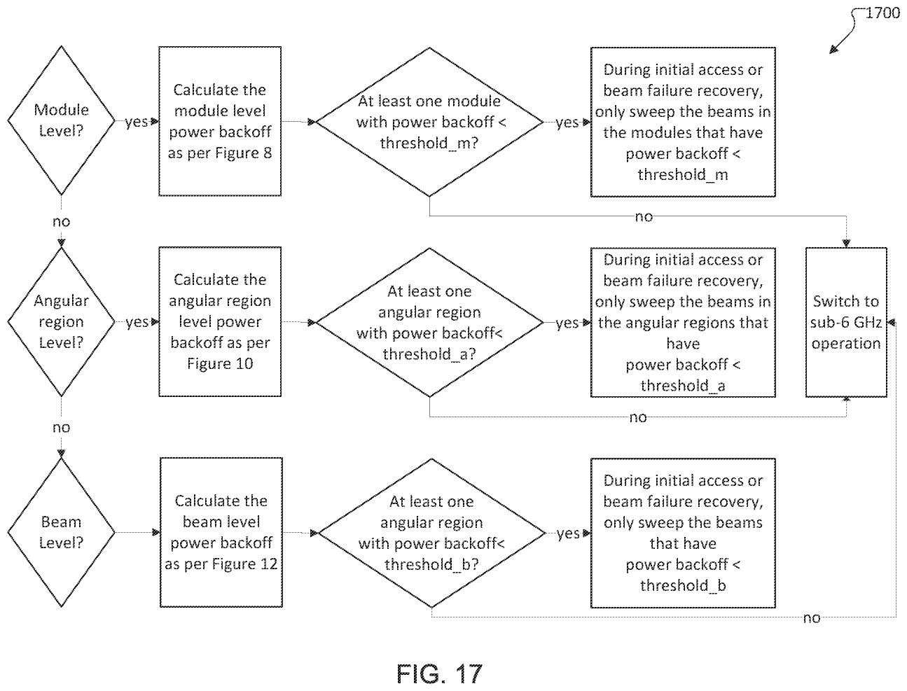

As described above, in the process 1500, the UE decides the UL/DL preference and subsequently uses a UE beam and reports the BS beam accordingly. FIG. 16 illustrates an example process 1600 for determining whether to prefer the UL or DL according to embodiments of the present disclosure. The process 1600, as performed by the UE for determining the UL or DL preference, relies on three pieces of information. These three pieces of information and their roles in making the UL/DL preference will now be discussed.

### 1. Active Application

The UE can obtain the nature of a currently active application (e.g., whether the currently active application is UL or DL intensive) by querying a look up table matching each application to its category (e.g., UL intensive, DL intensive). Some examples of UL intensive applications are file uploading, AR/VR/XR, and live streaming from the UE (e.g., camera video). Some examples of DL intensive applications are video streaming applications, cloud gaming, file downloading, and the like. In some embodiments, the look up table can be predetermined and stored at the UE since the typical traffic from each application is known.

If the currently active application is DL intensive, the UE decides to prefer the DL. Conversely, if the currently active application is UL intensive, the UE decides to prefer the UL. If information about the currently active application is not available, or the currently active applications include both UL and DL intensive applications, then the currently active application information is not used in deciding the UL/DL preference.

### 2. Recent History of UL/DL Usage

Based on the recent history of the UL/DL data consumption, if the recent data consumption has been higher for DL, the UE can decide to prefer the DL. If the recent data consumption has been higher for UL, the UE can decide to prefer the UL. If the recent data consumption history is not available, the UE can use a user indicated preference as discussed below. Note that for the case when the UE is using a mix of applications including both UL and DL intensive applications, the recent history can be an indicator on which applications are dominating the data consumption.

### 3. User Indicated Preference

The UE can allow the user to indicate whether DL or UL performance is to be prioritized in case the active application and the recent history of the UL/DL usage are not available. The user can make his or her determination using one or more phone settings.

When the user indicated preference is not available, a default option of giving preference to the DL can be used. This is because most user data consumption is typically DL.

In another alternative, a minimum required UL and DL throughput can be defined. The process 1500 of FIG. 15 can be performed only when the UL/DL BS beams can support the minimum UL and DL throughput. If either the best UL beam or the best DL beam cannot support minimum UL or DL throughput, the beam is immediately discarded, and another beam that can support minimum UL and DL throughput is used instead. If the best UL beam can support UL minimum throughput but cannot support DL minimum throughput, while the best DL beam can support DL minimum throughput but cannot support UL minimum throughput, then the process 1500 of FIG. 15 can be used.

In addition to the process 1500, it is possible to use sensor information to make the determination on whether to prefer DL or UL. As an example, if the temperature of the UE is high, the UE could decide to report the BS beam that corresponds to the UE beam with more power backoff. This way the UE will operate with reduced power consumption, which can help alleviate the high temperature issue. Similarly, if the UE battery is low, the UE may report the BS beam corresponding to the UE beam with more power backoff in order to conserve power. Simply put, in both the high temperature and lower battery situations, the UE should use the best DL beam, since the best DL beam would have more power backoff. These sensor input based UE preference determination mechanisms can be used in conjunction with the process 1500, or on their own.

### Beam Pruning in the Initial Access Phase

As discussed above, the UE 600 is equipped with multiple communication modules and multiple radar modules, such as shown in FIG. 6. For multi-module devices, such as the UE 600, to determine the best beam via beamforming as discussed above, typically the beams are swept one module at a time in a sequential manner. This is because activating a module requires power and incurs latency. This power and latency cost can be referred to as the module sweeping cost. Once all the modules on the UE 600 are swept, the module (and the beam) with highest signal strength is used for data transmission or reception. The latency of this initial search procedure is proportional to the total number of beams across all modules. When radars are available on the UE 600, this latency can be reduced substantially by taking into consideration the radar measurements.

FIG. 17 illustrates an example process 1700 for pruning the beams during the initial access or beam failure recovery phase, according to embodiments of the present disclosure. Three different types of power back off determination strategies were discussed earlier, i.e., module level, angular region level, and beam level. As shown in FIG. 17, for each of these power back off determination types—that depend on the capability of the radar mounted on the UE 600—first the UE 600 determines the power backoff. Then the UE 600 determines whether there is a module, an angular region, or a beam that has a power backoff less than the pre-specified threshold, for module level (i.e., threshold_m), angular region level (i.e., threshold_a), or beam level (i.e., threshold_b) power backoff determination, respectively. In general, a large power back off means that the module, angular region, or the beam is blocked, and cannot be used reliably for data transmission or reception. As such, the modules, angular regions, or the beams with less power backoff are more suitable for data transmission/reception.

The determination of the threshold can be made relative to the worst-case power back off, e.g., 0.7 p_{w}, i.e., 70% of the worst-case power backoff. It is clear that the range for the threshold is [0, p_{w}] with 0 indicating that only the module, angular region, or beams, with no power back off will be considered suitable for communication, whereas p_{w} indicates that nothing is considered suitable for communication. Setting the threshold can thus control the latency of the beam search process. Since there is no requirement to have the same threshold for module level, angular region level, and beam level power backoff determination, separate thresholds can be defined and used, i.e., threshold_m, threshold_a, and threshold_b. These thresholds can be set by looking at the statistics of the power backoff from measurements of different modules, angular regions, and beams. The initial access is limited only to this module, angular region, or beams that have power back off less than the pre-specified threshold. If there is no such module, angular region, or beams, then the UE 600 cannot operate at the mmWave frequencies and will need to limit itself to the sub-6 GHz operation.

If the RF exposure is severe and mmWave cannot be operated, it might still be possible to operate at sub-6 GHz. This is because mmWave communication is based on relatively large antenna arrays, and directional beamforming through these arrays can result in large effective isotropic radiated power (EIRP). In comparison, the communication at sub-6 GHz is based on a small number of antennas (e.g., often only one), and as such, it might still be possible to meet regulatory requirements at sub-6 GHz. Doing this would eliminate unnecessary sweeping of a blocked module and thus enhance the efficiency of module sweeping procedure. The same strategy described for the initial access can also be applied during the beam failure recovery phase.

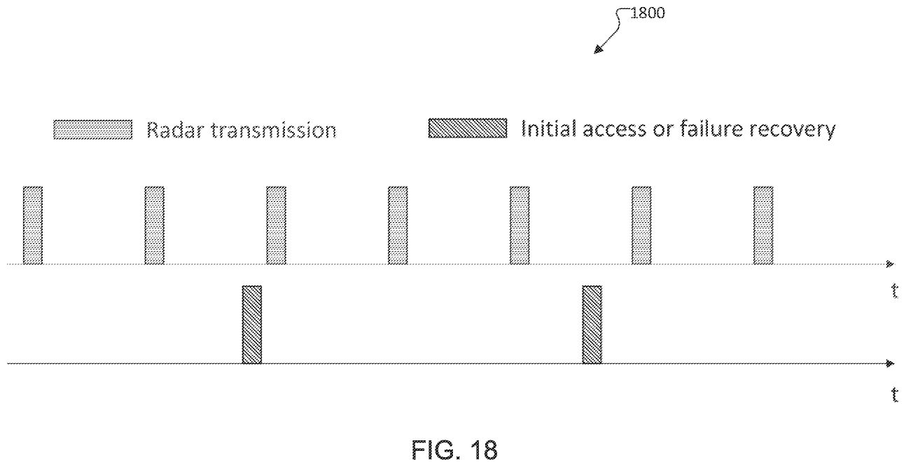

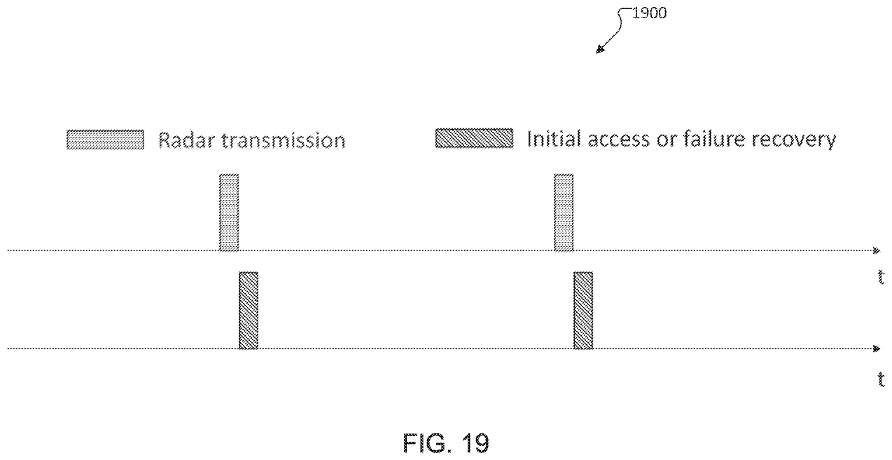

For the detection of the MPE violation or other proximity detection the radar could be activated periodically as shown in the timeline 1800 illustrated in FIG. 18. The other possibility is to tie the activation of the radar with the beam management operation itself, i.e., on demand radar activation as shown in the timeline 1900 illustrated in FIG. 19. Right before the initial access or beam failure recovery procedure, the radar is activated. The time phase other than the initial access or beam failure recovery is called the beam maintenance phase. In the beam maintenance phase, the radars can stay dormant since the overhead of maintaining a beam is less than the initial access or beam failure recovery. Since all radars on the device are facing different directions, it might be possible to activate all the radars at the same time before initial access or beam failure recovery. Subsequently, the beams are pruned based on the detection of the radar as discussed in FIG. 17.

### Best Module Determination

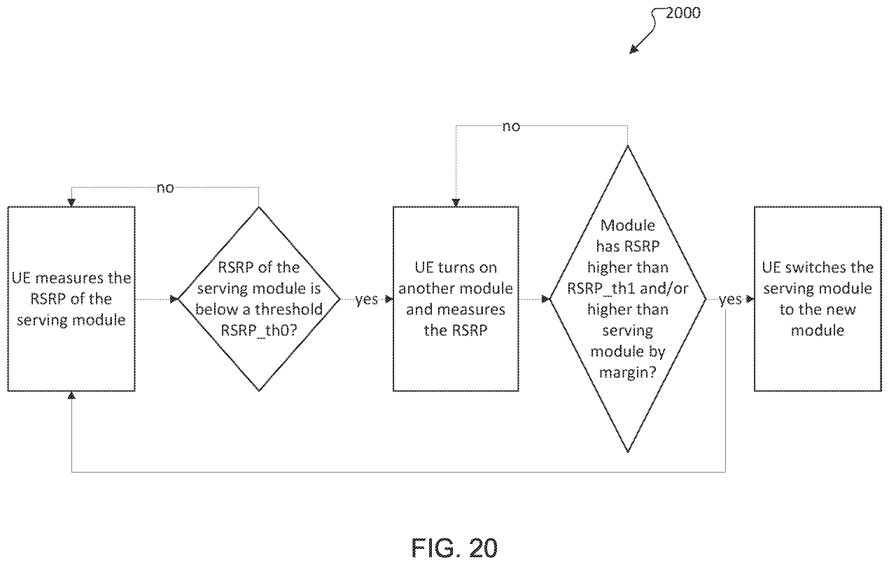

The procedure of collecting RF signals (i.e., making measurements) on different communication modules 602 on the UE 600 to determine the best communication module 602 is called module sweeping. Subsequently, if it is determined that a communication module is available which is better (in terms of some signal quality metric e.g., RSRP) than the communication module currently being used (referred to as the serving module), then the serving module is changed to the module that is determined to be a better module. This process is referred to herein as module switching. In order to reduce the number of communication modules that are continuously swept and to minimize the number of times the current serving module is switched, a process 2000 illustrated in FIG. 20 can be followed. As shown in FIG. 20, the UE measures the RSRP of the serving module. Herein, the RSRP of a communication module can be the RSRP of a representative beam on the module (e.g., a wide-beam in the boresight direction, or the maximum RSRP across all the beams of a module). As long as the RSRP of the serving module is above a threshold called RSRP_th0, the UE continues to use this serving module. When the RSRP of the serving module falls below the threshold RSRP_th0, then the UE turns on another communication module and measures the RSRP. If the RSRP of the new module is above a threshold RSRP_th1, and/or higher than the current serving module by a margin (e.g., 5 dB), then the UE switches the serving module to this module. Otherwise, the UE turns on another communication module and measures the RSRP on that module.

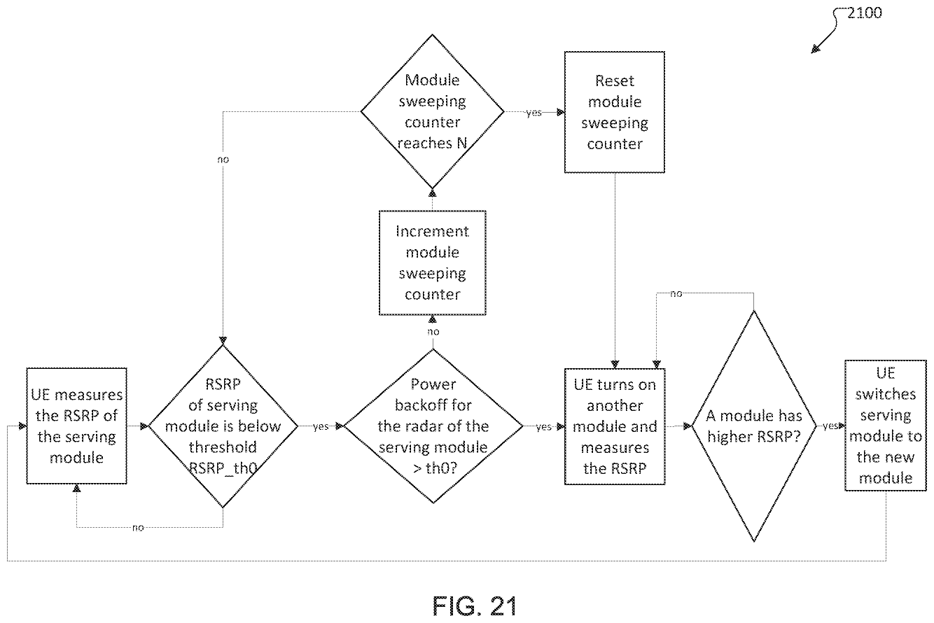

The limitation of the aforementioned procedure is that RSRP of the serving module can fall below RSRP_th0 due to several reasons, including measurement instability, noise, etc. As such, the input from the radar can be used in deciding whether other communication modules need to be searched. For example, FIG. 21 illustrates a process 2100 for module sweeping using radar information according to embodiments of the present disclosure. As shown in FIG. 21, if the RSRP of the serving module falls below a threshold RSRP_th0, then the UE checks if the power backoff for the radar of the serving module is greater than a prespecified threshold, th0. If there is a substantial power backoff then it is likely that the module is blocked, and the UE should switch to a different module, hence the UE measures a different module immediately. If the power backoff is not large, then the UE uses a counter to make sure that enough measurements have been made on the serving module and on all the measurements the RSRP is below the threshold RSRP_th0. This ensures that a noisy measurement or instability of a measurement is not an issue causing measured RSRP to fall below RSPR_th0. If, after several measurements, the RSRP remains below RSRP_th0, then the UE follows the subsequent steps that are the same as those in FIG. 20.

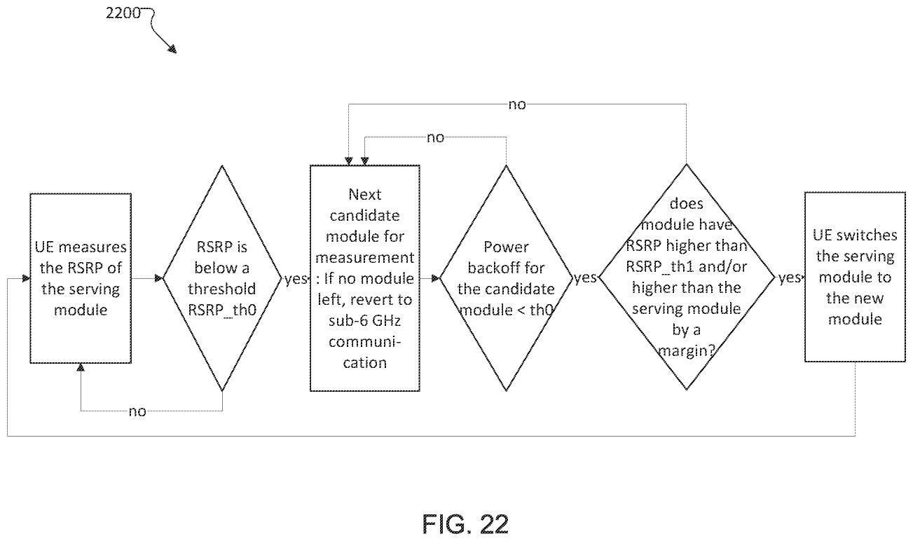

As discussed above, the UE can use the radar information in determining whether or not the module sweeping is required. The radar information can also be used for determining whether or not module switching is required. For example, FIG. 22 illustrates an example process 2200 for module switching using radar information according to embodiments of the present disclosure. As shown in FIG. 22, after the UE has decided that module sweeping is required, the UE decides to sweep another module called a candidate module. The UE performs RSRP measurements on the new candidate module only if the power backoff for the candidate module is less than the prespecified threshold, th0. This condition means that there is not a lot of power back off, and thus the module can be a good module for subsequent communication. Subsequently, RSRP is measured on this module, else a different module is tried. Finally, since it is possible that all modules are blocked, the process 2200 includes a condition to deal with such a scenario. Specifically, if the UE has gone through all the modules and no module satisfies the condition, the UE switches to sub-6 GHz communication.

As discussed above, the process 2100 of FIG. 21 incorporates radar information in the module sweeping phase, whereas the process 2200 of FIG. 22 incorporates radar information in the module switching phase. In other embodiments, the process 2100 and the process 2200 can be combined to incorporate the radar information in both the module sweeping and switching phases.

Although FIGS. 6 through 22 illustrate various processes and details related to beam management with radar based RF exposure estimation, various changes may be made to FIGS. 6 through 22. For example, various components in FIGS. 6 through 22 could be combined, further subdivided, or omitted and additional components could be added according to particular needs. In addition, various operations in FIGS. 6 through 22 could overlap, occur in parallel, occur in a different order, or occur any number of times.

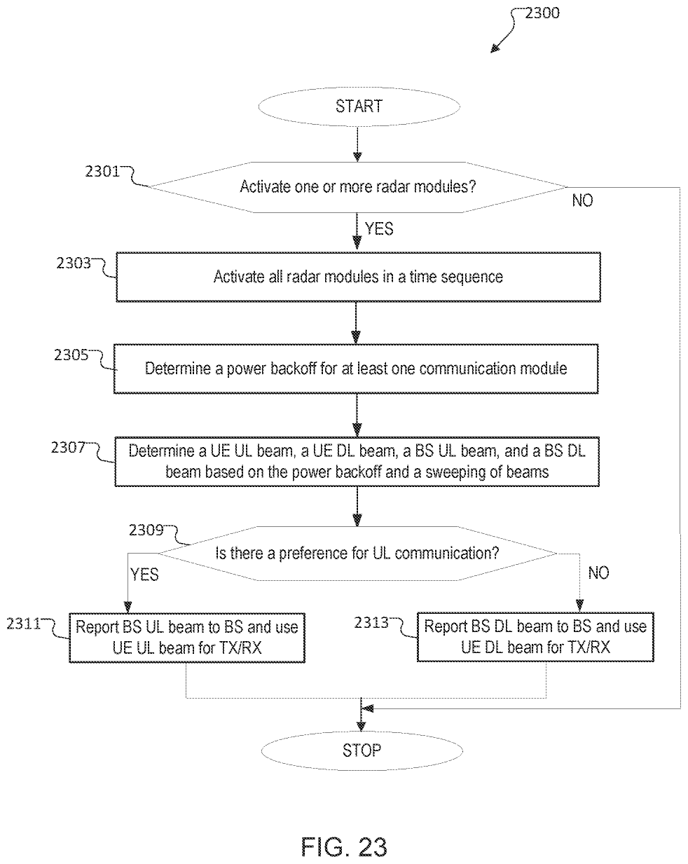

FIG. 23 illustrates a method 2300 for beam management with radar based RF exposure estimation according to embodiments of the present disclosure, as may be performed by one or more components of the network 100 (e.g., the UE 116). The embodiment of the method 2300 shown in FIG. 23 is for illustration only. One or more of the components illustrated in FIG. 23 can be implemented in specialized circuitry configured to perform the noted functions or one or more of the components can be implemented by one or more processors executing instructions to perform the noted functions.

As illustrated in FIG. 23, the method 2300 begins at step 2301. At step 2301, a UE determines whether or not to activate one or more radar modules based on whether the UE performs initial access or beam failure recovery. This could include, for example, the UE 116 determining whether or not to activate one or more radar modules 604 based on whether the UE 116 performs initial access or beam failure recovery, as shown in the timeline 1800 or the timeline 1900. If the UE determines to activate one or more radar modules 604, then the method 2300 continues to step 2303. Otherwise, the method 2300 ends.

At step 2303, the UE activates all of the one or more radar modules in a time sequence, one or multiple radar modules at a time. This could include, for example, the UE 116 activating the radar modules 604 in a time sequence, one or multiple radar modules at a time.

At step 2305, the UE determines a power backoff for at least one communication module of the UE. In some embodiments, the UE determines the power backoff based on a comparison of a FoV of the at least one communication module and a FoV of at least one of the one or more radar modules that correspond to the at least one communication module. In some embodiments, the power backoff for the at least one communication module is determined at a module level, an angular region level, or a beam level of the UE. This could include, for example, the UE 116 determining a power backoff for at least one communication module 602 based on a comparison of the FoV of the communication module 602 and the FoV of the radar module 604, such as by performing one of the processes 800, 1000, or 1200.

At step 2307, the UE determines a UE UL beam, a UE DL beam, a BS UL beam, and a BS DL beam based on the power backoff and a sweeping of beams of the UE. In some embodiments, the sweeping occurs for the beams of the UE that have a power backoff that is less than a threshold. This could include, for example, the UE 116 determining a best UE UL beam, a best UE DL beam, a best BS UL beam, and a best BS DL beam, such as by performing one of the processes 1400 or 1500, or portions thereof.

At step 2309, the UE determines whether there is a preference for UL communication when the BS UL beam is not the same as the BS DL beam. This could include, for example, the UE 116 performing one of the processes 1500 or 1600, or portions thereof. If the UE determines a preference for UL communication, then the method 2300 continues to step 2311. Otherwise, if the UE determines no preference for UL communication, then the method 2300 continues to step 2313.

At step 2311, the UE reports the BS UL beam to the BS, and uses the UE UL beam for data transmission and reception. This could include, for example, the UE 116 reporting the best BS UL beam to the gNB 102 and using the best UE UL beam for data transmission and reception, such as described in FIG. 15.

At step 2313, the UE reports the BS DL beam to the BS, and uses the UE DL beam for data transmission and reception. This could include, for example, the UE 116 reporting the best BS DL beam to the gNB 102 and using the best UE DL beam for data transmission and reception, such as described in FIG. 15.

Although FIG. 23 illustrates one example of a method 2300 for beam management with radar based RF exposure estimation, various changes may be made to FIG. 23. For example, while shown as a series of steps, various steps in FIG. 23 could overlap, occur in parallel, occur in a different order, or occur any number of times.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method comprising:
determining whether to activate one or more radar modules of a user equipment (UE) based on whether the UE performs initial access or beam failure recovery;
in response to determining that the one or more radar modules are to be activated:
activating all of the one or more radar modules in a time sequence, one or multiple radar modules at a time;
determining a power backoff for at least one communication module of the UE; and
determining a UE uplink (UL) beam, a UE downlink (DL) beam, a base station (BS) UL beam, and a BS DL beam based on the power backoff and a sweeping of beams of the UE,
wherein the sweeping occurs for the beams of the UE that have a power backoff that is less than a threshold.

2. The method of claim 1, wherein the power backoff for the at least one communication module is determined based on a comparison of a field of view (FoV) of the at least one communication module and a FoV of at least one of the one or more radar modules that correspond to the at least one communication module.

3. The method of claim 2, wherein the power backoff for the at least one communication module is determined at a module level, an angular region level, or a beam level of the UE.

4. The method of claim 1, further comprising:
when the BS UL beam is not the same as the BS DL beam, determining whether there is a preference for UL communication;
in response to a determination of the preference for UL communication, reporting the BS UL beam to the BS, and using the UE UL beam for data transmission and reception; and
in response to a determination of no preference for UL communication, reporting the BS DL beam to the BS, and using the UE DL beam for data transmission and reception.

5. The method of claim 4, wherein determining whether there is the preference for UL communication is based on at least one of: an active application, a recent history of UL and DL usage, or a user-indicated preference.

6. The method of claim 1, further comprising:
using the power backoff to assist in multi-module operation to determine:
which communication modules of the UE should be swept when a signal quality metric of a serving module falls below a second threshold; or
whether or not a switch from the serving module is to be performed.

7. The method of claim 6, further comprising performing module sweeping on only the communication modules that are determined to be swept.

8. A user equipment (UE) comprising:
a transceiver; and
a processor operably connected to the transceiver, the processor configured to:
determine whether to activate one or more radar modules of the UE based on whether the UE performs initial access or beam failure recovery;
in response to determining that the one or more radar modules are to be activated:
activate all of the one or more radar modules in a time sequence, one or multiple radar modules at a time;
determine a power backoff for at least one
communication module of the UE; and
determine a UE uplink (UL) beam, a UE downlink (DL) beam, a base station (BS) UL beam, and a BS DL beam based on the power backoff and a sweeping of beams of the UE,
wherein the sweeping occurs for the beams of the UE that have a power backoff that is less than a threshold.

9. The UE of claim 8, wherein the power backoff for the at least one communication module is determined based on a comparison of a field of view (FoV) of the at least one communication module and a FoV of at least one of the one or more radar modules that correspond to the at least one communication module.

10. The UE of claim 9, wherein the power backoff for the at least one communication module is determined at a module level, an angular region level, or a beam level of the UE.

11. The UE of claim 8, wherein the processor is further configured to:
when the BS UL beam is not the same as the BS DL beam, determine whether there is a preference for UL communication;
in response to a determination of the preference for UL communication, report the BS UL beam to the BS, and use the UE UL beam for data transmission and reception; and
in response to a determination of no preference for UL communication, report the BS DL beam to the BS, and use the UE DL beam for data transmission and reception.

12. The UE of claim 11, wherein the processor is configured to determine whether there is the preference for UL communication based on at least one of: an active application, a recent history of UL and DL usage, or a user-indicated preference.

13. The UE of claim 8, wherein the processor is further configured to:
use the power backoff to assist in multi-module operation to determine:
which communication modules of the UE should be swept when a signal quality metric of a serving module falls below a second threshold; or
whether or not a switch from the serving module is to be performed.

14. The UE of claim 13, wherein the processor is further configured to perform module sweeping on only the communication modules that are determined to be swept.

15. A non-transitory computer readable medium comprising program code that, when executed by a processor of a user equipment (UE), causes the UE to:
determine whether to activate one or more radar modules of the UE based on whether the UE performs initial access or beam failure recovery;
in response to determining that the one or more radar modules are to be activated:
activate all of the one or more radar modules in a time sequence, one or multiple radar modules at a time;
determine a power backoff for at least one communication module of the UE; and
determine a UE uplink (UL) beam, a UE downlink (DL) beam, a base station (BS) UL beam, and a BS DL beam based on the power backoff and a sweeping of beams of the UE,
wherein the sweeping occurs for the beams of the UE that have a power backoff that is less than a threshold.

16. The non-transitory computer readable medium of claim 15, wherein the power backoff for the at least one communication module is determined based on a comparison of a field of view (FoV) of the at least one communication module and a FoV of at least one of the one or more radar modules that correspond to the at least one communication module.

17. The non-transitory computer readable medium of claim 16, wherein the power backoff for the at least one communication module is determined at a module level, an angular region level, or a beam level of the UE.

18. The non-transitory computer readable medium of claim 15, further comprising program code that, when executed by the processor, causes the UE to:
when the BS UL beam is not the same as the BS DL beam, determine whether there is a preference for UL communication;
in response to a determination of the preference for UL communication, report the BS UL beam to the BS, and use the UE UL beam for data transmission and reception; and
in response to a determination of no preference for UL communication, report the BS DL beam to the BS, and use the UE DL beam for data transmission and reception.

19. The non-transitory computer readable medium of claim 18, wherein the program code causes the processor to determine whether there is the preference for UL communication based on at least one of: an active application, a recent history of UL and DL usage, or a user-indicated preference.

20. The non-transitory computer readable medium of claim 15, further comprising program code that, when executed by the processor, causes the UE to:
use the power backoff to assist in multi-module operation to determine:
which communication modules of the UE should be swept when a signal quality metric of a serving module falls below a second threshold; or
whether or not a switch from the serving module is to be performed.
